(19) United States
(12) Patent Application Publication
(10) Pub. No.: US 2017/0255954 A1
(43) Pub. Date: Sep. 7, 2017

(54) METHOD FOR INDIRECT SNS ADVERTISING AND SERVER FOR SAME

(71) Applicants: Sangwoo SONG, Seoul (KR); Cheol Choi, Seoul (KR)

(72) Inventors: Sangwoo SONG, Seoul (KR); Cheol Choi, Seoul (KR)

(21) Appl. No.: 15/442,832

(22) Filed: Feb. 27, 2017

(30) Foreign Application Priority Data
Mar. 2, 2016 (KR) 10-2016-0024841

(51) Int. Cl. G06Q 30/02; A63F 13/61; G06Q 50/00

(52) U.S. Cl. CPC G06Q 30/0209; G06Q 50/01; G06Q 30/0277; A63F 13/61

(57) ABSTRACT

A method for indirect SNS advertising includes: checking whether a level of a user possessing a user terminal is higher than a level eligible for participation in a specific quest when receiving a quest participation request massage from the user terminal; checking whether the number of participants of the specific quest exceeds the maximum number of participants when the user's level is more than the level eligible for participation; receiving and registering content corresponding to content of the quest from the user terminal when the number of participants does not exceed the maximum number of participants; and providing points to the user according to a matching result of the content and the content of the quest received from an advertiser terminal. Thus, it is possible to mediate between an advertiser and an advertising person through a quest created by the advertiser, whereby the advertiser can easily recruit the advertising person.

### CROSS REFERENCE TO RELATED APPLICATION

The present application claims priority to Korean Patent Application No. 10-2016-0024841, filed Mar. 2, 2016, the entire contents of which is incorporated herein for all purposes by this reference.

### BACKGROUND OF THE INVENTION

Field of the Invention

The present invention relates generally to a method for indirect SNS advertising and a server for the same.

Description of the Related Art

As the Internet has become more popular, the amount of advertising through the Internet has also increased, and advertising methods have also become more diverse. The following are methods of advertising using the Internet.

First, there is a method whereby a banner advertisement is inserted into a part of a web page so that people can see the advertisement.

Next, there is a method whereby visitors are induced to watch or read advertisement content. When the visitors visit a specific web page, a pop-up window in which the advertisement content is posted is displayed so that the visitor cannot read the content included in the web page unless the visitors perform another action such as closing the pop-up window.

Further, there is a method whereby the visitors are induced to watch or read the advertisement content. When the visitors click banner advertisements inserted on a specific website, the visitors are provided with a predetermined amount of money or the like.

When an advertisement is carried out by the above methods, advertisers calculate the advertising expenses based on the number of visitors to the website, the number of clicks of the banner advertisement, etc., and then provide calculation results to an operator of the web site.

However, many users pay minimal attention to the content of the banner advertisement inserted in the website. Further, even when the users click on the banner advertisement, the users usually click on the banner advertisement to obtain points or cash rather than being interested in the content of the advertisement. Thus, the effect of advertising through the Internet is often less than expected.

In other words, since general consumers pay little attention to advertisements through the Internet, the effect of the advertising is degraded. Further, the advertisers should spend the advertising expenses without knowing whether their advertisements appeal to many consumers and whether or how much their advertisements actually work. The above are reasons advertisers are hesitant to advertise on the Internet.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a method for indirect SNS advertising and a server for the same, wherein an advertiser and an advertising person are mediated through a quest created by the advertiser, whereby the advertiser can easily recruit the advertising person.

Further, the present invention is intended to propose a method for indirect SNS advertising and a server for the same, wherein a user is allowed to participate in a quest corresponding to a level of the user to thereby obtain a reward point, whereby participation rate of users in the quest can be increased.

Further, the present invention is intended to propose a method for indirect SNS advertising and a server for the same, wherein the level of the user is adjusted through participation in a quest for acquisition of experience points, whereby the user can participate in a quest with more reward points.

Further, the present invention is intended to propose a method for indirect SNS advertising and a server for the same, wherein when the number of participants in a quest is less than the desired number of people recruited after a closing date of the quest passes, a refund point is provided, whereby the advertiser can register the quest again by using the refund point.

Further, the present invention is intended to propose a method for indirect SNS advertising and a server for the same, wherein the user registers content corresponding to content of a quest after performing an authentication process for the content, whereby only authenticated content can be registered.

The object of the present invention is not limited to the above-mentioned object, and other objects not mentioned may be clearly understood by those skilled in the art from the description below.

In order to achieve the above object, according to one aspect of the present invention, there is provided a method for indirect SNS advertising, the method including: checking whether a level of a user possessing a user terminal is equal to or greater than a level eligible for participation in a specific quest when receiving a quest participation request massage about the specific quest on a quest list from the user terminal; checking whether the number of participants of the specific quest exceeds the maximum number of participants when the level of the user is equal to or greater than the level eligible for participation in the specific quest as a result of the checking the level of the user; receiving and registering content corresponding to content of the quest from the user terminal when the number of participants of the specific quest does not exceed the maximum number of participants as a result of the checking the number of participants; and providing points to an account associated with the user in accordance with a matching result of the content and the content of the quest received from an advertiser terminal.

According to another aspect of the present invention, there is provided a server for providing the indirect advertising service, the server including: a level management unit managing a level of a user in accordance with experience points for each user; a quest management unit managing a quest and a quest for acquisition of experience points both of which are created by an advertiser by registering the quest and the quest for acquisition on a quest list; a quest participation management unit checking whether the level of the user possessing a user terminal, the level being determined by the level management unit, is equal to or greater than a level eligible for participation in a specific quest when receiving a quest participation request message about the specific quest on the quest list from the user terminal, wherein when the level of the user is equal to or greater than the level eligible for participation as a result of the checking the level of the user, the quest participation management unit checks whether the number of participants in the specific quest exceeds the maximum number of participants, and when the number of participants of the specific quest does not exceed the maximum number of participants as a result of the checking the number of participants, the quest participation management unit receives and registers content corresponding to content of the quest from the user terminal; and a point management unit providing points to an account associated with the user in accordance with a matching result of the content and the content of the quest received from an advertiser terminal.

The details of other embodiments are included in the detailed description and the accompanying drawings.

The above and other objects, features and advantages of the present invention will be more clearly understood from the following detailed description taken in conjunction with the accompanying drawings. Embodiments of the present invention are presented to provide a complete disclosure of the present invention and help those who are ordinarily skilled in the art best understand the invention. Various changes to the following embodiments are possible and the scope of the present invention is not limited to the following embodiments. The scope of the present invention is defined only by the accompanying claims and their equivalents if appropriate. Throughout the drawings, the same reference numerals will refer to the same or like parts.

According to the present invention, it is possible to mediate between the advertiser and the advertising person through a quest created by the advertiser, and thus the advertiser can easily recruit the advertising person.

Further, according to the present invention, the user is allowed to participate in the quest corresponding to his or her level to thereby obtain a payment point as a reward for participating in the quest, and thus it is possible to increase the participation rate of users in the quest.

Further, according to the present invention, the level of the user is adjusted through participation in the quest for acquisition of experience points, and thus the user can participate in the quest with more reward points.

Further, according to the present invention, when the number of participants of the quest is less than the desired number of people recruited after the closing date of the quest passes, the refund point is provided, and thus the advertiser can register the quest again by using the refund point.

Further, according to the present invention, the user registers the content corresponding to the content of the quest after performing the authentication process for the content, and thus only the authenticated content can be registered.

Further, according to the present invention, it is possible to provide more jobs and profit sources to young people who love photography, and to achieve an economic effect of raising the minimum wage by competing with existing part-time jobs to reduce the demand for the part-time jobs. In addition, more jobs and higher minimum wage will have a beneficial impact on a country's GDP. Moreover, if an app user obtains a high-level in the app, it is possible to generate as much revenue as small and medium-sized businesses, to promote entrepreneurship among young people, and to benefit the economy. Finally, the quest for experience points will stimulate an internet culture and creative sense of users in accordance with its content, so it is possible to contribute to development of a better internet culture and user self-development.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view illustrating a network configuration of an indirect SNS advertising system according to an embodiment of the present invention;

FIG. 2 is a block diagram illustrating an internal structure of a server for providing the indirect advertising service according to the embodiment of the present invention;

FIG. 3 is a flow chart illustrating an embodiment of a method for providing the indirect advertising service according the present invention;

FIG. 4 is a flow chart illustrating another embodiment of the method for providing the indirect advertising service according to the present invention.

FIG. 5 is a flow chart illustrating a further embodiment of the method for providing the indirect advertising service according to the present invention; and

FIG. 6 is a flow chart illustrating a further embodiment of the method for providing the indirect advertising service according to the present invention.

### DETAILED DESCRIPTION OF THE INVENTION

Hereinbelow, exemplary embodiments of the present invention will be described in detail with reference to the accompanying drawings.

The term “quest” used herein refers to a mission created by an advertiser in order to recruit an advertising person who will register content in a server for providing an indirect advertising service. Here, the content may be indirect advertising content created when the advertising person is photographed with an advertising object in accordance with content of the quest.

The term “quest for acquisition of experience points” used herein refers to a mission registered by an administrator in the server for providing the indirect advertising service in order to adjust a level of a user.

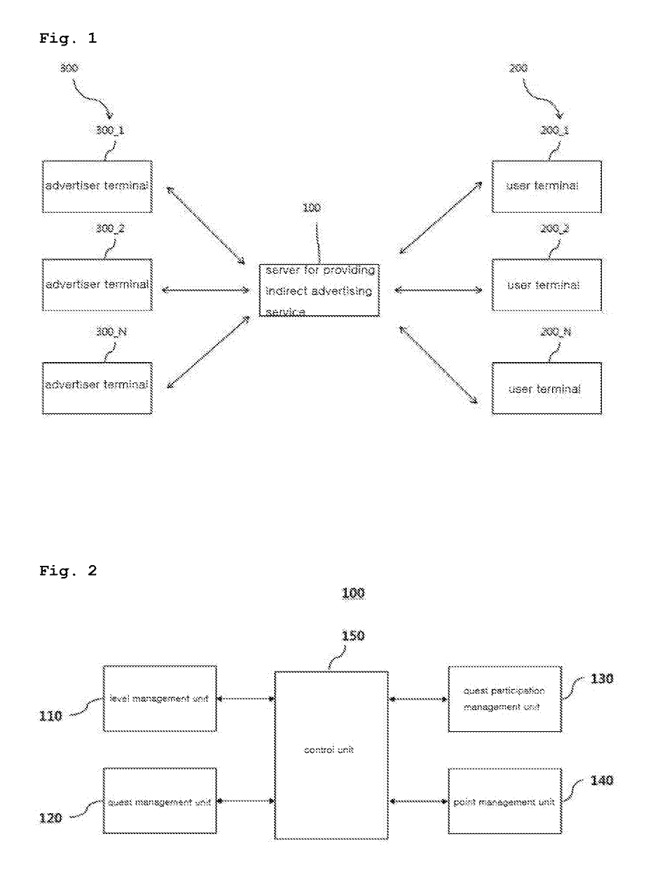

FIG. 1 is a view illustrating a network configuration of an indirect SNS advertising system according to an embodiment of the present invention.

Referring to FIG. 1, the indirect SNS advertising system includes a server 100 for providing the indirect advertising service, a user terminal 200, and an advertiser terminal 300.

The server 100 for providing the indirect advertising service denotes a server that performs an intermediary role of recruiting an advertising person by registering a quest for recruitment of the advertising person through the advertiser terminal 300. The server 100 for providing the indirect advertising service will be described in more detail with reference to FIG. 2 below.

The user terminal 200 denotes a terminal, which is possessed by the advertising person who connects to the server 100 for providing the indirect advertising service and participates in a quest to thereby provide indirect advertising, and which can be implemented via a PDA, a smart phone, a tablet PC, a laptop, or the like. Here, through the user terminal 200, a user participates in the quest and registers the indirect advertising content created when the user is photographed with the advertising object in accordance with the content of the quest, whereby the user can act as the advertising person.

For example, when the content of the quest directs the user to advertise a store A, the user terminal 200 registers indirect advertising content created when a user A is photographed with a user's friend at the store A, and thus the user A can act as the advertising person.

However, since the user can only participate in a quest corresponding to the level of the user, the user participates in a quest for acquisition of experience points to raise experience points. A process in which the user participates in the quest for acquisition of experience points and raises the level thereof will be described in more detail below.

The advertiser terminal 300 denotes a terminal, which is possessed by an advertiser who connects to the server 100 for providing the indirect advertising service, creates and registers a quest, and then recruits the advertising person through the quest, thereby obtaining effects of indirect advertising through the content registered in the quest by the advertising person, and which can be implemented via a PDA, a smart phone, a tablet PC, a laptop, or the like.

Each of the user terminal 200 and the advertiser terminal 300 may be provided with an application for accessing the server 100 for providing the indirect advertising service.

FIG. 2 is a block diagram illustrating an internal structure of the server for providing the indirect advertising service according to the embodiment of the present invention.

Referring to FIG. 2, the server 100 for providing the indirect advertising service includes a level management unit 110, a quest management unit 120, a quest participation management unit 130, a point management unit 140, and a control unit 150.

The level management unit 110 manages the level of the user in accordance with experience points of each user.

In an embodiment, when the user is a new member, the level management unit 110 may set the level of the user to a preset minimum level.

In another embodiment, when the user participates in the quest for acquisition of experience points, the level management unit 110 may raise the level of the user in accordance with a level to be raised, which is predetermined in the quest for acquisition of experience points.

In a further embodiment, the level management unit 110 may check the number of quests that a user has participated in and may raise the level of the user in accordance with the number of quests. For example, when the number of quests is equal to or greater than a certain number, the level management unit 110 may raise the level of the user by the predetermined level.

In a further embodiment, the level management unit 110 may raise the level of the user in accordance with an accumulation point, which is accumulated from a reward point provided when the user participates in the quest. For example, when the accumulation point is equal to or greater than a certain point, the level management unit 110 may raise the level of the user by the predetermined level.

In a further embodiment, the level management unit 110 may check the number of views for the content registered in the quest by the user, and may raise the level of the user in accordance with the number of views. For example, when the number of views for the content registered in the quest is equal to or greater than a certain number, the level management unit 110 may raise the level of the user by the predetermined level.

The quest management unit 120 manages the quest and the quest for acquisition of experience points that are created by the advertiser by registering the quest and the quest for acquisition of experience points on a quest list.

In an embodiment, the quest management unit 120 may create a quest including a closing date, an advertiser, location information of the advertising object, the desired number of people recruited, the reward point, and a level eligible for participation in response to a request from the advertiser and may register the quest on the quest list.

In this case, the closing date denotes a period during which a user can participate in the quest, and the advertiser denotes information of the advertiser registering the quest. The location information of the advertising object may be changed in accordance with the advertising object, wherein when the advertising object is a store, the location information of the advertising object may be location information of the store, and when the advertising object is an article, the location information of the advertising object may be set with respect to the whole country. The desired number of people recruited denotes the number of people who can participate in the quest, the reward point denotes a point provided to a user when the user participates in the quest, and the level eligible for participation denotes a level at which the user can participate in the quest.

In another embodiment, the quest management unit 120 may create a quest for acquisition of experience points including the closing date, the level to be raised, and quest content in the quest list in response to a request from the administrator and may register the quest on the quest list. Here, the quest for acquisition of experience points is used to allow a user to adjust his or her level through the quest.

The reason for adjusting the level of the user through the quest for acquisition of experience points is that the level eligible for participation is set for each quest created by the advertiser, so when the level of the user is lower than the level eligible for participation set in the quest, the user cannot participate in a corresponding quest.

Moreover, the reward point is set for each quest in accordance with the level eligible for participation, wherein when the level eligible for participation is high, the reward point is set high. Thus, when the level of the user is low, the user cannot participate in the corresponding quest to obtain the reward point.

The quest participation management unit 130 checks whether the user can participate in a specific quest when receiving a quest participation request message about the specific quest on the quest list from the user terminal 200.

For this purpose, the quest participation management unit 130 checks whether the level of the user, which is determined by the level management unit 110, is equal to or greater than the level eligible for participation set in the specific quest. When the level of the user is equal to or greater than the level eligible for participation, the quest participation management unit 130 checks whether the number of participants of the specific quest exceeds the maximum number of participants.

When it is determined that the number of participants of the specific quest exceeds the maximum number of participants, the quest participation management unit 130 provides a message indicating that the user cannot participate in the quest to the user terminal 200. On the other hand, when it is determined that the number of participants of the specific quest does not exceed the maximum number of participants, the quest participation management unit 130 receives and registers content corresponding to content of the quest.

In the above embodiment, when the user participates in the quest, the quest participation management unit 130 checks whether the number of quests that a user has participated in exceeds the number of quests available per day. When the number of quests that the user has participated in does not exceed the number of quests available per day, the user can participate in the quest.

The quest participation management unit 130 performs a process of authenticating content in the process of receiving and registering the content corresponding to the content of the quest, and registers only authenticated content in the quest.

To this end, when receiving the content corresponding the content of the quest, the quest participation management unit 130 extracts location information and date information from additional information of the content. Here, the location information is used to check that the content is created at a location of the advertising object set at the time of quest creation, and the date information is used to check that the content is created after quest creation.

The quest participation management unit 130 checks whether the location information exists within a specific area based on the location information of the advertising object set at the time of quest creation. That is, the quest participation management unit 130 checks whether the content is created at the location of the advertising object to be advertised by the advertiser.

The reason for performing the above process is to check whether the content created by the user is created at a certain branch or at another branch when the quest recruits the advertising person for the certain branch included in branches located in a plurality of regions.

When the location information exists within the specific area, the quest participation management unit 130 checks whether the content is created after a registration date of the quest by comparing information about the registration date of the quest and the date information. The reason for performing this process is that when the content registered by the user is photographed before the quest is created by the advertiser, accuracy of the content is degraded.

When it is determined that the content is created after the registration date of the quest, the quest participation management unit 130 registers the content in the quest.

Further, the quest participation management unit 130 provides a procedure for selecting action tags in the process of registering the content in the quest. Here, the action tag denotes a tag that sets options for postings.

In one embodiment, when a user selects an action tag for instructing refusal of opinion registration in the process of registering the content in the quest, the quest participation management unit 130 may set an opinion about the content not to be registered by another user, thereby registering the content in the quest. For example, when the user selects an action tag for refusing registration of “dislike”, the quest participation management unit 130 sets that no “dislike” button exists so that “dislike” about the content is not selected by another user.

The point management unit 140 manages points by providing and deducting points to and from an account of each user or each advertiser.

In an embodiment, the point management unit 140 provides points to an account associated with the user according to a matching result of the content and the content of the quest received from the advertiser terminal 300. In this embodiment, the point management unit 140 may provide the reward point to an account associated with the user in accordance with a reward point set at the time of quest creation.

In another embodiment, when the closing date of the quest registered in the quest list by the advertiser passes but not as many users are recruited as the desired number of people recruited, the point management unit 140 may provide the refund point to an account associated with the advertiser.

In this embodiment, when the closing date of the quest passes, the point management unit 140 determines whether as many users are recruited as the desired number of people recruited by comparing the desired number of people recruited and the number of participants of the quest. As a result of the checking the users, when not as many users are recruited as the desired number of people recruited, the point management unit 140 determines the reward point set at the time of quest creation, determines the refund point in accordance with the shortage of people out of the desired number of people recruited, and provides the refund point to a point account associated with the advertiser.

The point management unit 140 converts points accumulated in the user's account to cash to provide points in accordance with a request for conversion of points to cash from the user.

The control unit 150 controls other components of the server 100 for providing the indirect advertising service to provide a process of providing the indirect advertising service.

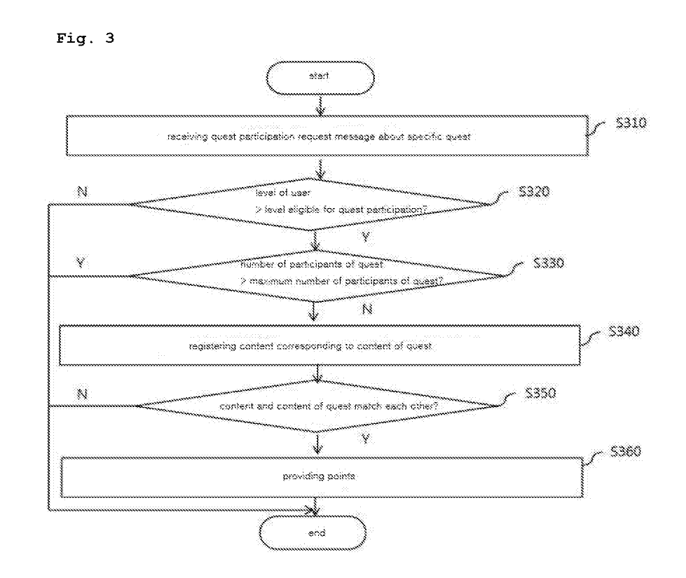

FIG. 3 is a flow chart illustrating an embodiment of a method for providing the indirect advertising service according to the present invention. The embodiment disclosed in FIG. 3 relates to an embodiment in which a user may participate in a quest to receive points.

Referring to FIG. 3, the server 100 for providing the indirect advertising service receives a quest participation request message about a specific quest on a quest list from a user terminal 200 (step S310). The server 100 for providing the indirect advertising service checks whether a level of the user possessing the user terminal 200 is equal to or greater than a level eligible for participation in the specific quest (step S320).

When the level of the user is equal to or greater than the level eligible for participation in the specific quest (step S320), the server 100 for providing the indirect advertising service checks whether the number of participants of the specific quest exceeds the maximum number of participants (step S330).

When the number of participants of the specific quest does not exceed the maximum number of participants (step S330), the server 100 for providing the indirect advertising service receives and registers content corresponding to content of the quest from the user terminal 200 (step S340). Although not shown in FIG. 3, when the number of participants of the specific quest exceeds the maximum number of participants, the server 100 for providing the indirect advertising service provides the user terminal 200 with a message indicating that the user cannot participate in the specific quest.

When it is determined that the content and the quest content match each other based on a matching result of the content and the content of the quest that are received from the advertiser terminal 300 (step S350), the server 100 for providing the indirect advertising service provides points to an account associated with the user (step S360).

In an embodiment of step S360, the server 100 for providing the indirect advertising service may provide a reward point set by an advertiser at the time of quest creation to the account associated with the user.

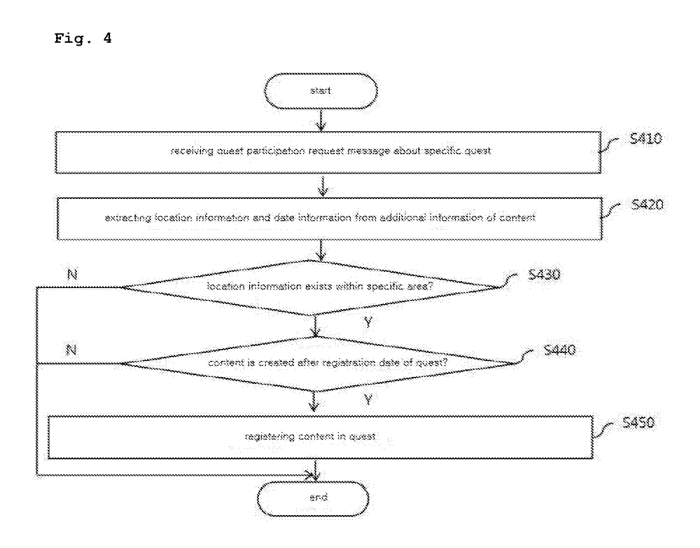

FIG. 4 is a flow chart illustrating another embodiment of the method for providing the indirect advertising service according to the present invention. The another embodiment disclosed in FIG. 4 relates to an embodiment in which a user may authenticate content to register the content corresponding to the content of the quest, thereby registering authenticated content.

Referring to FIG. 4, the server 100 for providing the indirect advertising service receives the content corresponding to the content of the quest from the user terminal 200 (step S410). The server 100 for providing the indirect advertising service extracts location information and date information from additional information of the content (step S420). Here, the location information is used to check whether the content is created at a location of an advertising object set at the time of quest creation, and the date information is used to check whether the content is created after quest creation.

The server 100 for providing the indirect advertising service checks whether the location information exists within a specific area based on location information of the advertising object set at the time of quest creation (step S430).

In other words, the server 100 for providing the indirect advertising service checks whether the content is created at the location of the advertising object to be advertised by the advertiser. The reason for performing this process is to check whether the content created by a user is created in a specific branch or in another branch when the quest recruits an advertising person for the specific branch included in branches located in a plurality of regions.

For example, when the quest recruits an advertising person for a branch A included in the branches, the server 100 for providing the indirect advertising service checks whether the content created by the user is created in the branch A or in a branch other than the branch A.

When the location information exists within the specific area (step S430), the server 100 for providing the indirect advertising service checks whether the content is created after a registration date of the quest (step S440) by comparing information about the registration date of the quest and the date information. The reason for performing this process is that when the content registered by the user is photographed before the quest is created by the advertiser, accuracy of the content is degraded.

When the content is created after the registration date of the quest (step S440), the server 100 for providing the indirect advertising service registers the content in the quest (step S450).

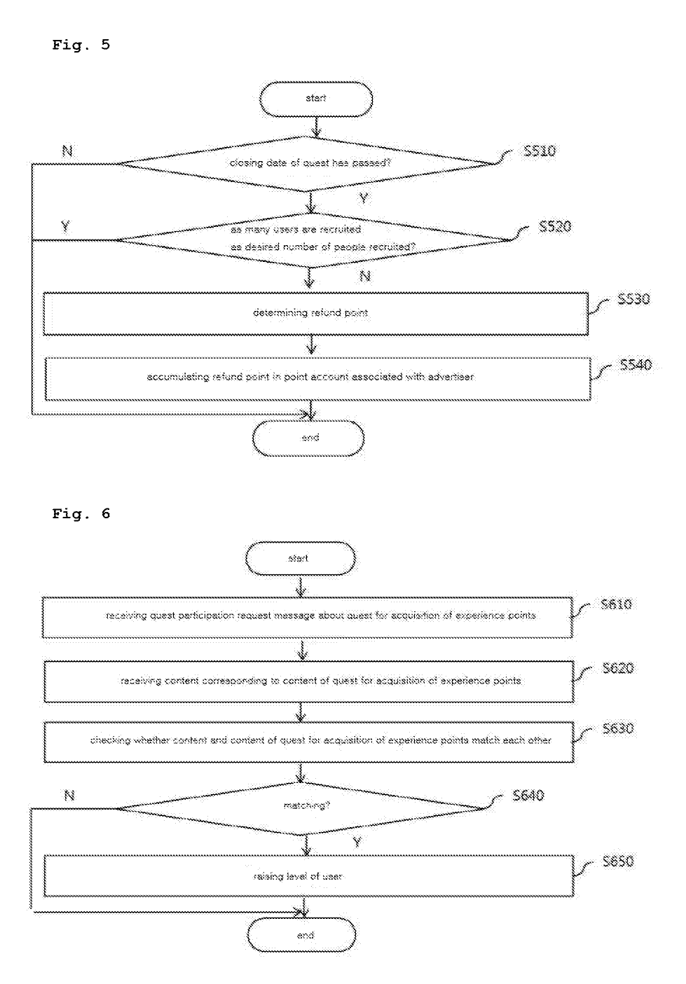

FIG. 5 is a flow chart illustrating a further embodiment of the method for providing the indirect advertising service according to the present invention. The further embodiment disclosed in FIG. 5 relates to an embodiment in which when the quest created by the advertiser is closed, points may be accumulated in an account associated with the advertiser depending on whether users corresponding to the desired number of people recruited are recruited.

Referring to FIG. 5, the server 100 for providing the indirect advertising service checks whether the closing date of the quest registered on the quest list by the advertiser has passed (step S510). When the closing date of the quest has passed (step S510), the server 100 for providing the indirect advertising service determines whether as many users are recruited as the desired number of people recruited (step S520).

When not as many users are recruited as the desired number of people recruited (step S520), the server 100 for providing the indirect advertising service determines the reward point set at the time of quest creation, and determines a refund point in accordance with the shortage of people out of the desired number of people recruited (step S530). In other words, the server 100 for providing the indirect advertising service may determine the refund point corresponding to the shortage of people in accordance with the reward point provided by the advertiser to each user participating in the quest.

The server 100 for providing the indirect advertising service accumulates the refund point in a point account associated with the advertiser (step S540). Thus, the advertiser can utilize points accumulated in the point account when creating and registering the quest.

FIG. 6 is a flow chart illustrating a further embodiment of the method for providing the indirect advertising service according to the present invention. The further embodiment disclosed in FIG. 6 relates to an embodiment in which the level of the user may be adjusted through the quest for acquisition of experience points.

Referring to FIG. 6, the server 100 for providing the indirect advertising service receives a participation request for the quest for acquisition of experience points from the user terminal 200 (step S610). The server 100 for providing the indirect advertising service receives content corresponding to content of the quest for acquisition of experience points from the user terminal 200 (step S620). The server 100 for providing the indirect advertising service checks whether the content and the content of the quest for acquisition of experience points match each other (step S630). When the content and the content of the quest for acquisition of experience points match each other (step S640), the server 100 for providing the indirect advertising service raises the level of the user (step S650). Here, the server 100 for providing the indirect advertising service can raise the level of the user in accordance a level to be raised set when the quest for acquisition of experience points is created.

As described above, the reason for adjusting the level of the user through the quest for acquisition of experience points is that the level eligible for participation is set for each quest created by the advertiser, so when the level of the user is lower than the level for participation set in the quest, the user cannot participate in the quest.

In addition, the reward point is set for each quest in accordance with the level eligible for participation. When the level eligible for participation is high, the reward point is set high. Thus, when the level of the user is low, the user cannot participate in the quest and cannot obtain the reward point.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the scope of the invention should be determined on the basis of the descriptions in the appended claims, not any specific embodiment, and all equivalents thereof should belong to the scope of the invention.

Although the invention is described with reference to specific items such as specific structural elements, to merely some embodiments, and to drawings, such specific details disclosed herein are merely representative for purposes of helping provide a more comprehensive understanding of the present invention. The present invention, however, is not limited to only the example embodiments set forth herein, and those skilled in the art will appreciate that the present invention can be embodied in many alternate forms. Accordingly, the present invention is intended to cover not only the exemplary embodiments, but also various alternatives, modifications, equivalents and other embodiments that may be included within the spirit and scope of the present invention as defined by the appended claims.

What is claimed is:

1. A method for indirect SNS advertising, the method comprising:
checking whether a level of a user possessing a user terminal is equal to or greater than a level eligible for participation in a specific quest when receiving a quest participation request massage about the specific quest on a quest list from the user terminal;
checking whether the number of participants of the specific quest exceeds the maximum number of participants when the level of the user is equal to or greater than the level eligible for participation in the specific quest as a result of the checking the level of the user;
receiving and registering content corresponding to content of the quest from the user terminal when the number of participants of the specific quest does not exceed the maximum number of participants as a result of the checking the number of participants; and
providing points to an account associated with the user in accordance with a matching result of the content and the content of the quest received from an advertiser terminal.

2. The method of claim 1, further comprising:
creating a quest including a closing date, an advertiser, location information of an advertising object, the desired number of people recruited, a reward point, and the level eligible for participation in response to a request from the advertiser, and registering the quest on the quest list,
wherein the reward point is changed in accordance with the level eligible for participation.

3. The method of claim 2, wherein
the receiving and registering the content corresponding to the content of the quest from the user terminal further includes:
extracting location information and date information from additional information of the content;
checking whether the location information exists within a specific area based on the location information of the advertising object;
checking whether the content is created after a registration date of the quest by comparing information about the registration date of quest and the date information when the location information exists within the specific area as a result of the checking the location information; and
registering the content in accordance with a result of the checking the content.

4. The method of claim 2, wherein
the receiving and registering the content corresponding to the content of the quest from the user terminal further includes:
providing a procedure for selecting action tags in a process of registering the content in the quest; and
setting an opinion about the content not to be registered by another user when selecting an action tag for instructing refusal of opinion registration in the action tags, thereby registering the content in the quest.

5. The method of claim 2, further comprising:
checking whether as many users are recruited as the desired number of people recruited by comparing the desired number of people recruited and the number of participants of the quest when the closing date of the quest registered on the quest list by the advertiser passes;
determining the reward point and determining a refund point in accordance with the shortage of people out of the desired number of people recruited when not as many users are recruited as the desired number of people recruited as a result of the checking the users; and
providing the refund point to a point account associated with the advertiser.

6. The method of claim 1, further comprising:
creating a quest for acquisition of experience points and registering the quest on the quest list;
receiving and registering content corresponding to content of the quest for acquisition of experience points from the user terminal in response to a request from the user for participation in the quest for acquisition of experience points; and
increasing the level of the user in accordance with a matching result of the content and the content of the quest for acquisition of experience points.

7. A server for providing an indirect advertising service, the server comprising:
a level management unit managing a level of a user in accordance with experience points for each user;
a quest management unit managing a quest and a quest for acquisition of experience points both of which are created by an advertiser by registering the quest and the quest for acquisition on a quest list;
a quest participation management unit checking whether the level of the user possessing a user terminal, the level being determined by the level management unit, is equal to or greater than a level eligible for participation in a specific quest when receiving a quest participation request message about the specific quest on the quest list from the user terminal, wherein when the level of the user is equal to or greater than the level eligible for participation as a result of the checking the level of the user, the quest participation management unit checks whether the number of participants of the specific quest exceeds the maximum number of participants, and when the number of participants in the specific quest does not exceed the maximum number of participants as a result of the checking the number of participants, the quest participation management unit receives and registers content corresponding to content of the quest from the user terminal; and
a point management unit providing points to an account associated with the user in accordance with a matching result of the content and the content of the quest received from an advertiser terminal.

8. The server of claim 7, wherein the quest management unit creates a quest including a closing date, an advertiser, location information of an advertising object, the desired number of people recruited, a reward point, and a level eligible for participation in response to a request from the advertiser, and registers the quest on the quest list,
wherein the reward point is changed in accordance with the level eligible for participation.

9. The server of claim 8, wherein the quest participation management unit extracts location information and date information from additional information of the content, and checks whether the location information exists within a specific area based on the location information of the advertising object, wherein when the location information exists within the specific area as a result of the checking the location information, the quest participation management unit checks whether the content is created after the registration date of the quest by comparing information about a registration date of the quest and the date information, and then registers the content in accordance with a result of the checking the content.

10. The server of claim 8, wherein the quest participation management unit provides a procedure for selecting action tags in a process of registering the content in the quest, wherein when an action tag for instructing refusal of opinion registration is selected, the quest participation management unit sets an opinion about the content not to be registered by another user and registers the content in the quest.

11. The server of claim 8, wherein when the closing date of the quest registered on the quest list by the advertiser passes, the point management unit determines whether as many users are recruited as the desired number of people recruited by comparing the desired number of people recruited and the number of participants of the quest, wherein when not as many users are recruited as the desired number of people recruited as a result of determining the users, the point management unit determines the reward point, determines a refund point in accordance with the shortage of people out of the desired number of people recruited, and provides the refund point to a point account associated with the advertiser.

12. The server of claim 7, wherein when the quest participation management unit receives and registers content corresponding to content of the quest for acquisition of experience points from the user terminal in response to a request from the user for participation in the quest for acquisition of experience points, the quest participation management unit creates a matching result of the content and the content of the quest for acquisition of experience points, and
the level management unit increases the level of the user in accordance with the matching result of the content and the content of the quest for acquisition of experience points.
